(19) United States
(12) Patent Application Publication
(10) Pub. No.: US 2017/0243315 A1
(43) Pub. Date: Aug. 24, 2017

(54) SYSTEM FOR VERIFYING A CONSUMERS BIOMETRIC COMMUNICATION DEVICE THROUGH A DIGITAL WALLET FOR THE DELIVERY OF A PRODUCT

(71) Applicant: David Ellerstein, DELRAY BEACH, FL (US)

(72) Inventor: David Ellerstein, DELRAY BEACH, FL (US)

(21) Appl. No.: 15/439,221

(22) Filed: Feb. 22, 2017

Related U.S. Application Data
(60) Provisional application No. 62/299,255, filed on Feb. 24, 2016.

(51) Int. Cl. G06Q 50/28; G06K 19/06; G06Q 20/36; G06Q 10/10; G06Q 30/00

(52) U.S. Cl. CPC G06Q 50/28; G06Q 10/1097; G06Q 30/01; G06Q 20/363; G06K 19/06037

(57) ABSTRACT

Disclosed is a system for verifying a consumer's biometric communication device through a digital wallet for delivery of a product by a company. The system includes a database, a graphical user and plurality of modules comprising code that executes in the processor. The plurality of modules includes a consumer registration module, a delivery schedule module, a code module, a code retrieve module, a delivery person scan module and a verification module. The consumer registration module allows the companies to register a consumer on the database. The delivery schedule module allows the company to select a registered consumer, registered address of the consumer, date and time of delivery and a tracking number for scheduling the delivery. The code module allows the company to generate and send a code for placement in the digital wallet of the consumer's biometric communication device for the verification of the consumer at the time of delivery. The code retrieve module allows the consumer to retrieve code from the digital wallet sent by the company. The code is then displayed on the graphical user interface of the consumer's biometric communication device upon receiving biometric sensing from the registered consumer. The delivery person scan module allows scanning of the intended package tracking SKU code and the code retrieved by the consumer through a delivery person communicating device. The verification module verifies the code received from the registered consumer and further authorizes the delivery person to deliver the product to the consumer upon validation of the code.

### CROSS REFERENCE TO RELATED APPLICATION

The present application claims the benefit of U.S. Provisional Application No. 62/299,255, filed Feb. 24, 2016 which is incorporated by reference herein for all purposes.

### BACKGROUND OF THE INVENTION

1. Field of the Invention

The present invention generally relates to a method and a system for verifying a consumer's biometric device, and more particularly relates to a method and a system for verifying a consumer's biometric device through product specific information for the delivery of product through the use of a biometrically accessed digital wallet.

2. Description of Related Art

Scientists are discovering ever more physical and psychological benefits to the use of cannabis known commonly as marijuana, including but not limited to the ability to kill cancer cells found in an individual's brain and the ability to provide pain relief. Currently, many websites have started promoting the online purchase and selection of various cannabis/marijuana products for direct to consumer home delivery via courier.

Mobile App and online shopping is quickly becoming the preferred means for obtaining consumer products and services. More consumers, for example, are now using the Internet and Mobile Apps to browse, comparison shop and order products online. However, due to the highly regulated nature of the cannabis/marijuana, the dissemination of information regarding legal marijuana needs to be limited to only those individuals legally authorized to receive it. This is especially critical for the home delivery of such a highly regulated product such as cannabis.

Such products need to prevent access by individuals including but not limited to: (1) unauthorized sellers, such as individuals who want to intercept information regarding legal marijuana activities to attempt to lure individuals into illegal activities; and (2) unauthorized purchasers such as individuals who are underage or who are in a geographic area where the government prohibits the advertising, sale, purchase, possession and/or usage of legal marijuana and (3) to ensure that any individual that purchases for delivery is absolutely the individual which is indeed to receive the delivered good.

Therefore, there is a need of a system for directly verifying a consumer's biometric device of which has been uniquely paired. Further, the system should be able to validate through use of two-factor authentication to a singular individual for the delivery of a product using a more secure method such as through placement of confirmation code through a biometrically accessed digital wallet.

### SUMMARY OF THE INVENTION

In accordance with teachings of the present invention, a system for verifying a consumer's biometric communication device through a digital wallet for delivery of a product by a company is provided.

An object of the present invention is to provide a system including a database for storing pertinent information of consumers and companies, a processor coupled to the database, a graphical user interface coupled to the processor and plurality of modules comprising code that executes in the processor.

The plurality of modules includes a consumer registration module, a delivery schedule module, a code module, a code retrieve module, a delivery person scan module and a verification module. The consumer registration module allows the companies to register a consumer on the database. Further, the consumer registration module uses two-factor authentication providing further assurance of the 1:1 pairing of an individual with their unique mobile device.

The delivery schedule module allows the company to select a registered consumer, registered address of the consumer, as provided through scanning and storing photographic image of individual from government issued Identification to the database, date and time of delivery and a tracking number for scheduling the delivery. The code module allows the company to generate and send a random unique code for placement in the digital wallet of the consumer's biometric communication device for the verification of the consumer at the time of delivery.

The code retrieve module allows the consumer to retrieve code, by means of biometric access, from the digital wallet sent by the company. The code is then displayed on the graphical user interface of the consumer's biometric communication device upon receiving biometric sensing from the registered consumer. The delivery person scan module allows scanning of the code retrieved by the consumer through a delivery person communicating device.

The verification module verifies the code received from the registered consumer and further authorizes the delivery person to deliver the product to the consumer upon validation of the code. Preferably, the delivery person scans code in the biometric communication device using camera of their device. The retrieved information is verified and saved in the database for chain of custody transaction purposes and record keeping reconciliation.

Another object of the present invention is to provide the system where the consumer registration module uniquely registers and pairs the consumer's biometric communication device with the database. Further, the consumer retrieves code biometrically from the digital wallet in presence of the delivery person.

Another object of the present invention is to provide a reschedule delivery module to reschedule the delivery of the product on failure to receive confirmation from the consumer about being available for receiving of the product. In addition to fingerprint biometrics, alternative biometric authentication may be made by including, but not limited to facial recognition, voice recognition or iris scan of the consumer, ultimately consumer device dependent.

These and other features and advantages will become apparent from the following detailed description of illustrative embodiments thereof, which is to be read in connection with the accompanying drawings.

### BRIEF DESCRIPTION OF DRAWINGS

FIG. 1 illustrates a block diagram of a system for verifying a consumer's biometric communication device through a digital wallet for delivery of a product in a preferred embodiment of the present invention;

FIG. 2 illustrates a screenshot showing of consumer register module in accordance with an exemplary embodiment of the present invention;

FIG. 3 illustrates a screenshot showing of a delivery schedule module in accordance with an exemplary embodiment of the present invention;

FIG. 4 illustrates a screenshot showing of a code module in accordance with an exemplary embodiment of the present invention;

FIG. 5 illustrates a screenshot showing of a code retrieve module in accordance with an exemplary embodiment of the present invention;

FIG. 6 illustrates a screenshot showing of a delivery person scan module in accordance with an exemplary embodiment of the present invention;

FIG. 7A illustrates a screenshot showing of a verification module in accordance with an exemplary embodiment of the present invention;

FIG. 7B illustrates another screenshot showing of the verification module 700 depicting verification of the consumer in accordance with an exemplary embodiment of the present invention;

FIG. 7C illustrates another screenshot showing of the verification module 700 depicting verification failure in accordance with an exemplary embodiment of the present invention;

FIG. 8 illustrates a screenshot showing of a dashboard module in accordance with an exemplary embodiment of the present invention; and

FIG. 9 illustrates a screenshot showing of a reschedule delivery module in accordance with an exemplary embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF DRAWINGS

While this technology is illustrated and described in a preferred embodiment, a system for managing and distributing resource in an optimized manner to complete tasks may be produced in many different configurations, forms and computer languages. There is depicted in the drawings, and will herein be described in detail, as a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the technology described herein.

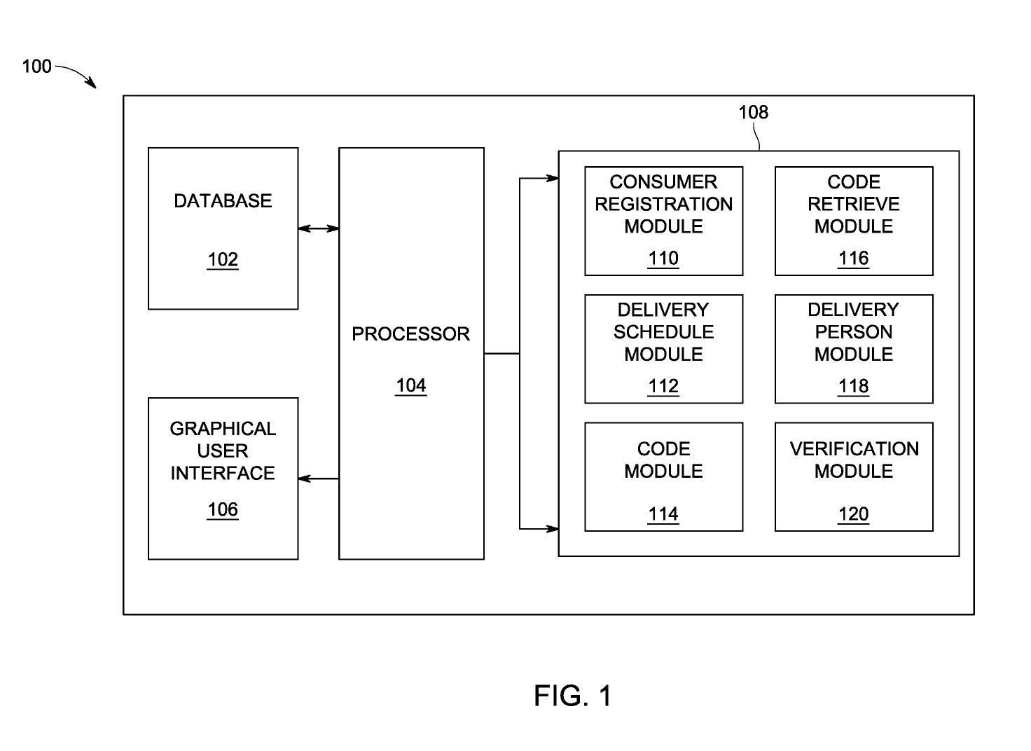

FIG. 1 illustrates a block diagram of a system 100 for verifying a consumer's biometric communication device through a digital wallet for delivery of a product in a preferred embodiment of the present invention. The system 100 includes a database 102 for storing pertinent information of consumers and companies, a processor 104 coupled to the database 102, a graphical user interface 106 coupled to the processor 104 and plurality of modules 108 comprising code that executes in the processor 104.

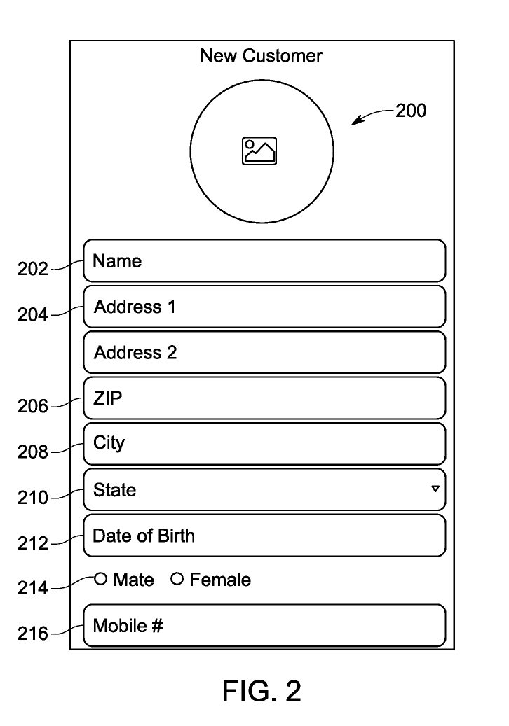

The plurality of modules 108 includes a consumer registration module 110, a delivery schedule module 112, a code module 114, a code retrieve module 116, a delivery person scan module 118 and a verification module 120. The consumer registration module 110 allows the companies to register a consumer on the database 102. The consumer registration module 110 is explained in detail in conjunction with FIG. 2 of the present invention.

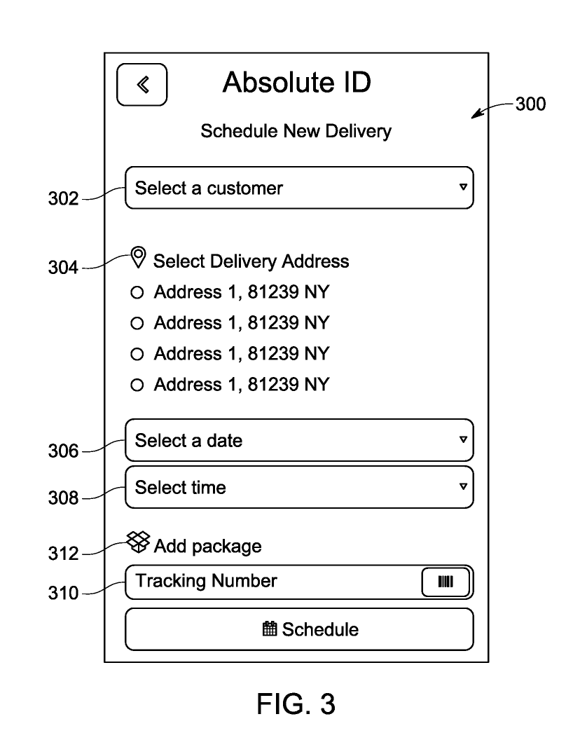

The delivery schedule module 112 allows the company to select a registered consumer, registered address of the consumer, date and time of delivery and a tracking number for scheduling the delivery. The delivery schedule module 112 is explained in detail in conjunction with FIG. 3 of the present invention.

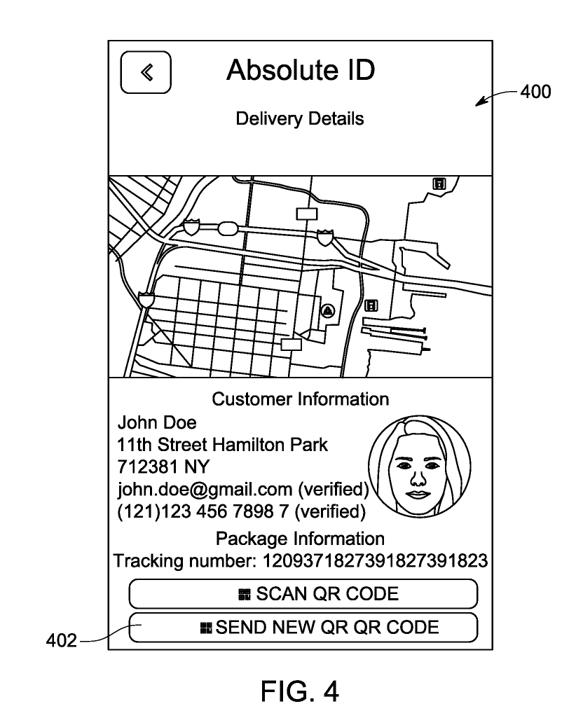

The code module 114 allows the company to generate and send a code for placement in the digital wallet of the consumer's biometric communication device for the verification of the consumer at the time of delivery. The code module 114 is explained in detail in conjunction with FIG. 4 of the present invention.

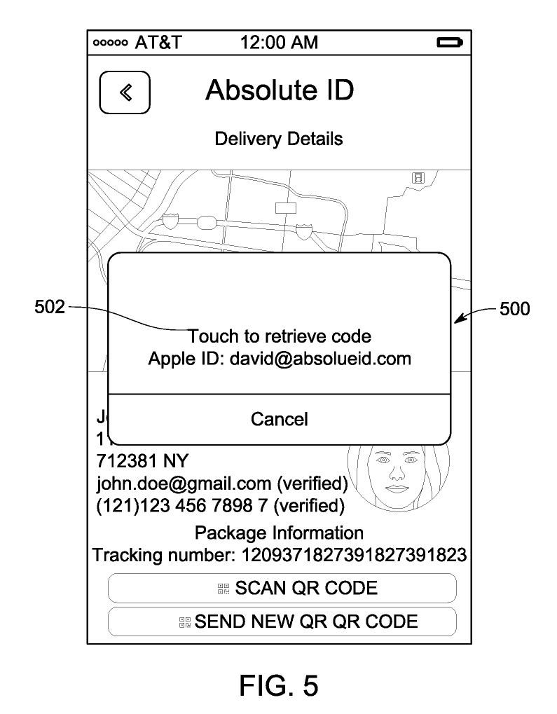

The code retrieve module 116 allows the consumer to retrieve code from the digital wallet sent by the company. The code is displayed on the graphical user interface 106 of the consumer's biometric communication device upon receiving biometric sensing from the registered consumer. The code retrieve module 116 is explained in detail in conjunction with FIG. 5 of the present invention.

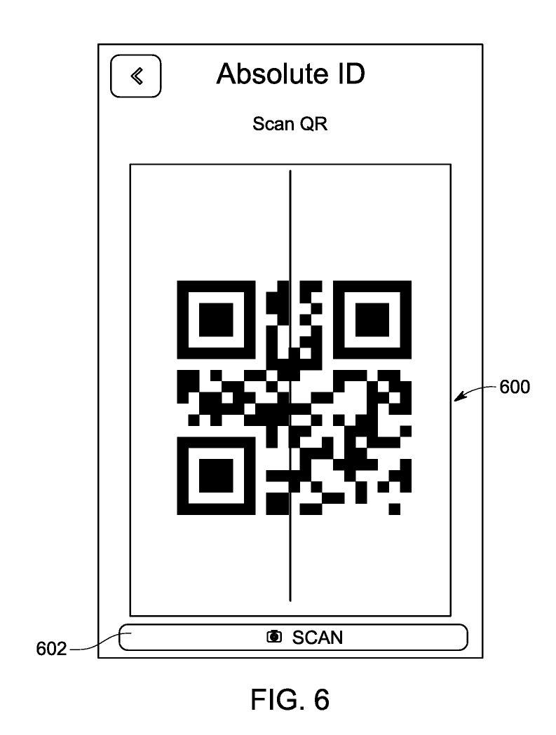

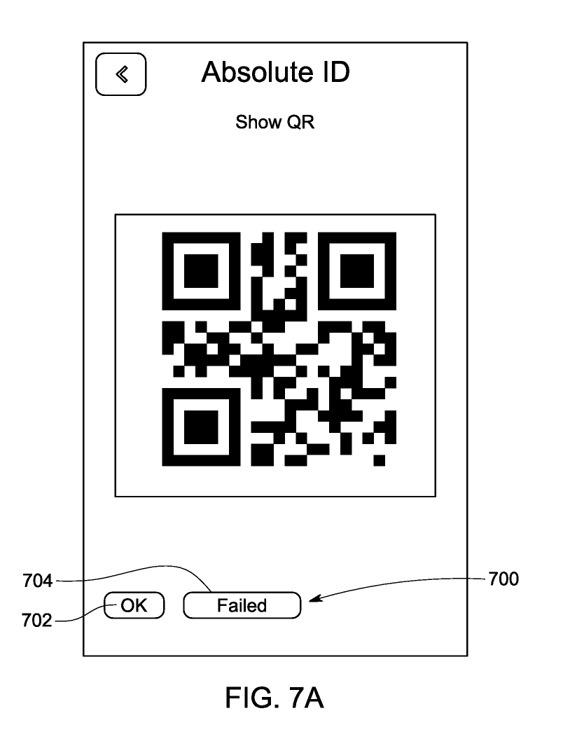

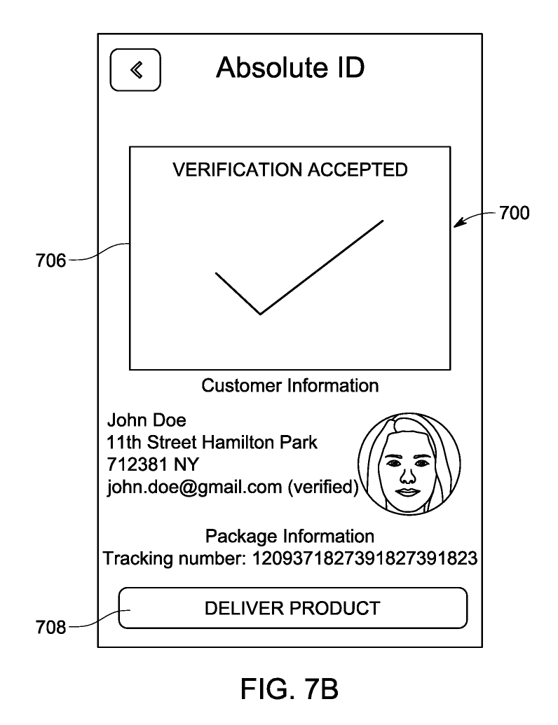

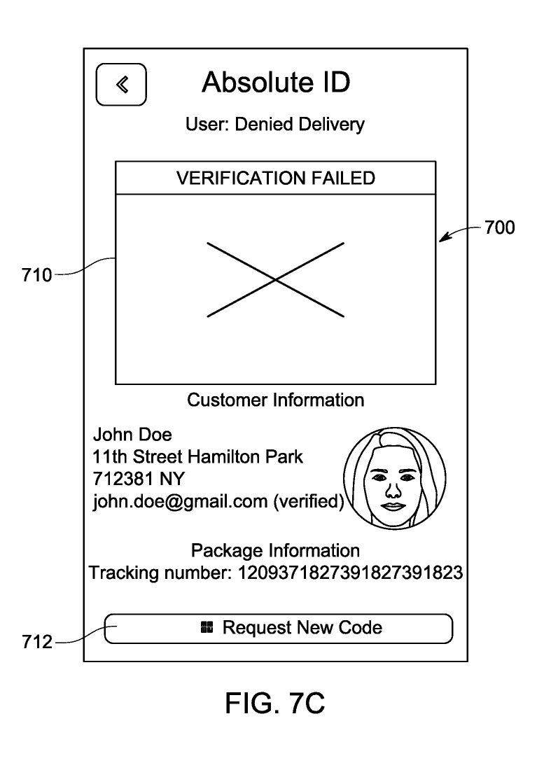

The delivery person scan module 118 allows scanning of the code retrieved by the consumer through a delivery person communicating device. The verification module 120 verifies the code received from the registered consumer through the delivery person scan module 118 and further authorizes the delivery person to deliver the product to the consumer upon validation of the code. The delivery person scan module 118 and the verification module 120 are explained in detail in conjunction with FIG. 6 and FIG. 7A, 7B respectively of the present invention.

Examples of the delivery person communicating device and consumer's biometric communication device includes but not limited to a smartphone, iPad, notebooks, tablets, smart watches and other phone having mobile/wireless/cellular/WiFi or internet facility to transfer code to the database.

FIG. 2 illustrates a screenshot showing of consumer register module 200 in accordance with an exemplary embodiment of the present invention. The consumer register module 200 allows registration of consumers on the database. In a preferred embodiment, the companies authenticate by absolute association of the consumer's biometric communication device paired to the consumer using two-factor authentication so that the consumer is verifiably registered before delivering the products.

The company sends verification code to the mobile phone of the customer. The customer then provides back the verification code to the company for verification of the mobile phone. This ensures that the address and other details of the customers are correct. The customer is allowed to change the address at any time before the delivery, but only so long as it is a confirmed previously registered address of the consumer.

In order to register the consumer on the database, the consumer may be asked to provide various information including but not limited to name 202, address 204, zip 206, city 208, state 210, date of birth 212, sex 214, mobile number 216, photo and email. It would be readily apparent to those skilled in the art that various information may be asked from the consumer at any step of registration without deviating from the scope of the present invention.

FIG. 3 illustrates a screenshot showing of a delivery schedule module 300 in accordance with an exemplary embodiment of the present invention. The delivery schedule module 300 allows the company to select a registered consumer 302, registered address of the consumer 304, date 306 and time 308 of delivery and a tracking number 310 for scheduling the delivery.

The tracking number 310 may be automatically or manually generated for specific delivery of each delivery of product. The company may further add package details 312 to the database associated with the delivery of product. Thus, by providing necessary details to the database the company schedules the delivery of the product to the consumer. In a preferred embodiment of the present invention, the package details include a tracking SKU code. The SKU code is to be scanned by the delivery person before delivering the product to the consumer.

FIG. 4 illustrates a screenshot showing of a code module 400 in accordance with an exemplary embodiment of the present invention. The code module 400 allows the company to generate and send a code 402 for placement in the digital wallet of the consumer's biometric communication device for the verification of the consumer at the time of delivery.

In a preferred embodiment of the present invention, the code 402 is a QR code. However, it would be readily apparent to those skilled in the art that various type of code may be send to the consumer without deviating from the scope of the present invention. The code module 402 then allows the consumer to add the code to the digital wallet.

In a preferred embodiment of the invention, the digital wallet is an internal digital wallet such as Apple Wallet™ or a Google Wallet™. The internal digital wallet refers to a repository built-in the smartphone to temporary store receipts, tickets and other documents. Those skilled in the art may envision various digital wallets that are from companion applications downloaded on the smartphones, without deviating from the scope of the present invention.

FIG. 5 illustrates a screenshot showing of a code retrieve module 500 in accordance with an exemplary embodiment of the present invention. The code retrieve module 500 allows the consumer to retrieve code 502 from the digital wallet sent by the company. The code is displayed on the graphical user interface of the consumer's biometric communication device upon receiving biometric sensing from the registered consumer.

Examples of biometric sensing include but not limited to facial recognition, voice recognition, fingerprinting, or the iris scan etc. The consumer retrieves the code when the delivery person is on the door step to deliver the product. The code retrieve module 500 ensures that the registered consumer is retrieving the code in the presence of the delivery person.

In a preferred embodiment of the present invention, the code retrieve module 500 is displayed for few seconds on the graphical user interface. Thus this ensures that consumer retrieves the code upon biometric authentication in presence of the delivery person and the product is delivered to the registered consumer. In a preferred embodiment, if the time expires, either the consumer requests a new code to be sent or the delivery person does so upon arriving at the delivery address.

FIG. 6 illustrates a screenshot showing of a delivery person scan module 600 in accordance with an exemplary embodiment of the present invention. The delivery person scan module 600 scans the code in the consumer's biometric communication device using the delivery person communicating device.

In another preferred embodiment of the present invention, the code may also represent a tracking code on the product that is intended for delivery to the consumer. The delivery person scans the tracking code on the product before delivering it to the consumer. This ensures that the correct product is delivered to the verified registered consumer.

The delivery person communication device uses camera to scan the code retrieved on the consumer's biometric communication device. The delivery person scan module 600 then sends the code to the database for verification. In a preferred embodiment, the database is a server, which stores and processes the modules (108, as shown in FIG. 1).

FIG. 7A illustrates a screenshot showing of a verification module 700 in accordance with an exemplary embodiment of the present invention. The verification module 700 compares the code received from the delivery person communication device with the code send to the consumer's biometric communication device.

The verification module 700 verifies the code either as OK 702 and Failed 704. Further, the verification module 700 sends authorization to delivery person communication device to deliver the product to the consumer if the code matches. FIG. 7B illustrates another screenshot showing of the verification module 700 depicting verification of the consumer in accordance with an exemplary embodiment of the present invention.

For example, the verification module 700 verifies the code, and then displays a check/verified mark 706 on the delivery person communication device. Further, the verification module 700 displays deliver product 708 to allow the delivery person to deliver the product to the consumer.

FIG. 7C illustrates another screenshot showing of the verification module 700 depicting verification failure in accordance with an exemplary embodiment of the present invention. For example, the verification module 700 does not accept the code to verify the consumer. Then, the verification module 700 displays a cancel sign 710 on the delivery person communication device.

Further, the verification module 700 displays a request new code 712 on the delivery person communication device to allow the delivery person to request a new code on behalf of the consumer. It would be readily apparent to those skilled in the art that the consumer may also generate a new code in case the previous code is not accepted, without deviating from the scope of the present invention.

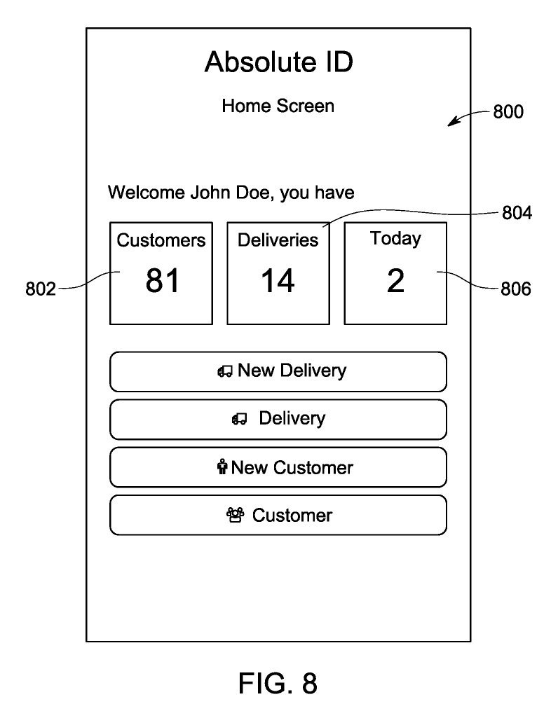

FIG. 8 illustrates a screenshot showing of a dashboard module 800 in accordance with an exemplary embodiment of the present invention. The dashboard module 800 allows the company to check total customers 802, total deliveries 804, and deliveries today 806. Further, the dashboard module 800 is linked to delivery schedule module and consumer registration module.

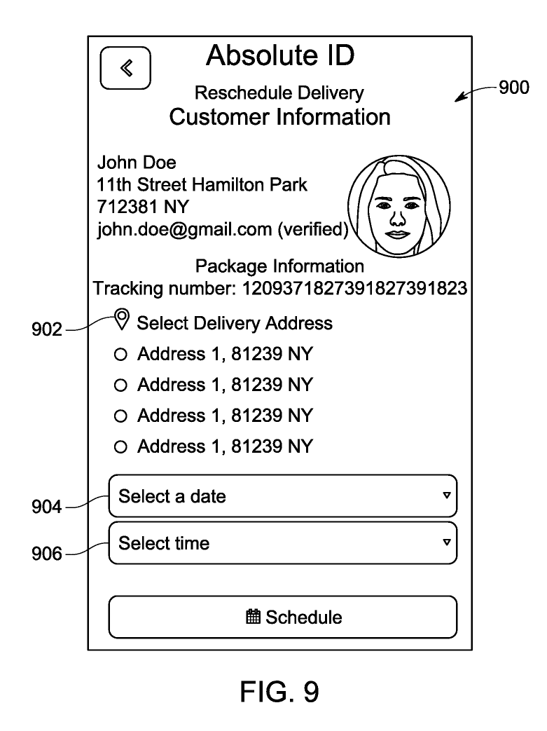

FIG. 9 illustrates a screenshot showing of a reschedule delivery module 900 in accordance with an exemplary embodiment of the present invention. The reschedule delivery module 900 reschedules the delivery of the product on failure to receive confirmation from the consumer about being available for receiving of the product.

The reschedule delivery module 900 sends a delivery schedule message to the consumer and if the consumer fails to respond to the delivery schedule message, then the reschedule delivery module 900 contacts the consumer to reschedule the delivery of the product. The reschedule delivery module 900 schedules by confirming address 902, date 904 and time 906 to ensure recipient is available to receive good upon delivery as the biometric verification is necessary.

The present invention offers various advantages such as ensuring authenticated deliveries of the product to the right address and to the right consumer.

The present invention offers secure delivery of products such as marijuana to the legal person.

Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

1. A system for verifying a consumer's biometric communication device through a digital wallet for delivery of a product by a company, the system comprising:
a database for storing pertinent information of consumers and companies;
a processor coupled to the database;
a graphical user interface coupled to the processor; and
plurality of modules comprising code that executes in the processor, comprising:
a consumer registration module for allowing the companies to register a consumer on the database;
a delivery schedule module for allowing the company to select a registered consumer, registered address of the consumer, date and time of delivery and a tracking number for scheduling the delivery;
a code module for allowing the company to generate and send a code for placement in the digital wallet of the consumer's biometric communication device for the verification of the consumer at the time of delivery;
a code retrieve module for allowing the consumer to retrieve code from the digital wallet sent by the company, wherein the code is displayed on the graphical user interface of the consumer's biometric communication device upon receiving biometric sensing from the registered consumer;
a delivery person scan module allows scanning of the code retrieved by the consumer through a delivery person communicating device; and
a verification module for verifying the code received from the registered consumer through the delivery person scan module and further authorizes the delivery person to deliver the product to the consumer upon validation

2. The plurality of modules according to claim 1 wherein the consumer registration module further uniquely registers and pairs the consumer's biometric communication device with the database.

3. The plurality of modules according to claim 1 further comprising a reschedule delivery module to reschedule the delivery of the product on failure to receive confirmation from the consumer about being available for receiving of the product.

4. The system according to claim 1 wherein the consumer retrieves code biometrically from the digital wallet in presence of the delivery person.
